(19) United States
(12) Patent Application Publication
(10) Pub. No.: US 2012/0115716 A1
(43) Pub. Date: May 10, 2012

(54) Surface Modified Activated Carbon Sorbent

(76) Inventors: Benedict Yorke Johnson, Horseheads, NY (US); Steven Bolaji Ogunwumi, Painted Post, NY (US); Millicent Kaye Weldon Ruffin, Painted Post, NY (US)

(21) Appl. No.: 12/942,308

(22) Filed: Nov. 9, 2010

(51) Int. Cl. B01D 53/64; B01J 20/22; B01D 15/00

(52) U.S. Cl. 502/401; 210/681; 95/133

(57) ABSTRACT

A flow-through substrate having a treated activated carbon surface, useful, for example, in the removal of a toxic metal from a fluid.

### FIELD OF THE DISCLOSURE

The disclosure relates generally to a flow-through substrate having a treated activated carbon surface, useful, for example, in the removal of a toxic metal from a fluid.

### BACKGROUND

The emission of toxic metals has become an environmental issue of increasing concern because of the dangers posed to human health. For instance, coal-fired power plants and medical waste incineration are major sources of human activity related to toxic metal emission into the atmosphere. However, emission control regulations have not been rigorously implemented for coal-fired power plants. A major reason is a lack of effective control technologies available at a reasonable cost.

A technology currently in use for controlling mercury emissions from coal-fired power plants is activated carbon injection (ACI). The ACI process involves injecting activated carbon powder into a flue gas stream and using a fabric filter or electrostatic precipitator to collect the activated carbon powder that has sorbed mercury. ACI technologies generally require a high C:Hg ratio to achieve the desired mercury removal level, which results in a high cost for sorbent material. The high C:Hg ratio indicates that ACI does not utilize the mercury sorption capacity of carbon powder efficiently.

An activated carbon packed bed can reach high mercury removal levels with more effective utilization of sorbent material. On the other hand, a typical powder or pellet packed bed has a very high pressure drop, which significantly reduces energy efficiency. Further, these fixed beds are generally an interruptive technology because they require frequent replacement of the sorbent material.

Some gas streams may contain agents that would inhibit the sorption of toxic metals on sorbents such as activated carbon honeycombs and other sorbent compositions and structures.

### SUMMARY

Disclosed herein is a flow-through substrate for overcoming activated carbon sorbent degradation or poisoning produced by acid gases, and comprises a method of treating the activated carbon sorbent to improve the performance of the activated carbon sorbent in capturing a toxic metal in the presence of acid gases.

Embodiments disclosed herein include a flow-through substrate comprising a treated activated carbon surface wherein the treated activated carbon surface comprises acidic functional groups, and wherein the treated activated carbon surface comprises a hydrophobic compound.

Also disclosed is a method comprising treating a flow through substrate comprising an activated carbon surface to form a treated activated carbon surface, wherein the treating comprises contacting an acid or oxidizing agent to the activated carbon surface, and contacting a hydrophobic compound to the activated carbon surface.

In addition, a method comprising contacting a fluid stream comprising a toxic metal with the flow-through substrate as described above and removing at least a portion of the toxic metal from the fluid stream is disclosed.

Additional features and advantages will be set forth in the detailed description which follows, and in part will be readily apparent to those skilled in the art from the description or recognized by practicing the embodiments as described in the written description and claims hereof.

It is to be understood that both the foregoing general description and the following detailed description are merely exemplary, and are intended to provide an overview or framework to understand the nature and character of the claims.

### DETAILED DESCRIPTION

Embodiments disclosed herein include a flow-through substrate comprising a treated activated carbon surface wherein the treated activated carbon surface comprises acidic functional groups and wherein the treated activated carbon surface comprises a hydrophobic compound.

The flow-through substrate comprises a treated activated carbon surface. In some embodiments, the flow-through substrate may comprise activated carbon, glass, glass-ceramic, ceramic, metal or combinations thereof. In some embodiments, the activated carbon may be coated, or otherwise disposed, on a flow-through substrate.

Treating the activated carbon surface includes oxidation or acid modification of the activated carbon surface to introduce acidic functional groups to the surface, and impregnation of the activated carbon surface with a hydrophobic compound. The treated activated carbon surface comprises acidic functional groups, for example, phenol, carbonyl, lactone, carboxyl, quinine, and hydroxyls. The treated activated carbon surface comprises a hydrophobic compound, for example, perfluorinated alcohol, methylated medium chain alkyl silanes, and linear or branched hydrocarbons of the general formula CₙH₂ₙ₊₂, wherein n equals 9 to 12, such as nonane.

In some embodiments, the treated activated carbon surface has a pH of from about 2 to about 7, for example, about 2.5, about 3, about 4, about 5, about 6, or about 7.

The term “flow-through substrate” as used herein means a shaped body comprising inner passageways, such as straight or serpentine channels and/or porous networks that would permit the flow of a gas stream through the structure. The flow-through substrate comprises a dimension in the flow-through direction of at least 1 cm, at least 2 cm, at least 3 cm, at least 4 cm, at least 5 cm, at least 6 cm at least 7 cm, at least 8 cm, at least 9 cm, or at least 10 cm from the inlet to the outlet.

In some embodiments, the flow-through substrate is honeycomb shaped comprising an inlet end, an outlet end, and inner channels extending from the inlet end to the outlet end. In some embodiments, the honeycomb shaped flow-through substrate comprises a multiplicity of cells extending from the inlet end to the outlet end, the cells being defined by intersecting cell walls. The honeycomb shaped flow-through substrate could optionally comprise one or more selectively plugged cell ends to provide a wall flow-through structure that allows for more intimate contact between the fluid stream and cell walls. In some embodiments, the flow-through substrate is monolithic.

Some embodiments of flow-through substrates may have a relatively high surface area to weight ratio. For example, in some embodiments, activated carbon honeycomb flow-through substrates disclosed herein can have a surface area to weight ratio of at least 5 m²/g, at least 100 m²/g, at least 250 m²/g, at least 400 m²/g, at least 500 m²/g, at least 750 m²/g, or even at least 1000 m²/g. In some embodiments, the surface area to weight ratio of a treated activated carbon surface is in the range of from 50 m²/g to 2500 m²/g, from 200 m²/g to 1500 m²/g, from 400 m²/g to 1200 m²/g.

The flow-through substrates disclosed herein may have a pore microstructure. For example, in one embodiment, the flow-through substrates comprise a total open pore volume or porosity of at least about 10%, at least about 15%, at least about 25%, or at least about 35%. In some embodiments, the total porosity is in the range of from about 15% to about 70%, including porosities of about 20% to about 60%, about 20% to about 40%, and about 40% to about 60%.

In some embodiments, the channel density of a honeycomb shaped flow-through substrate disclosed herein can range from 6 cells per square inch (cpsi) to 1200 cpsi, for example, 9 cpsi to 50 cpsi, 50 cpsi to 100 cpsi, 100 cpsi to 300 cpsi, 300 cpsi to 500 cpsi, 500 cpsi to 900 cpsi, or 900 cpsi to 1000 cpsi. In some embodiments, the wall thickness between the channels may range from 0.001 inches to 0.100 inches, or 0.02 inches to 0.08 inches.

Exemplary flow-through substrates of some embodiments may be made by extrusion, compression, injection molding, or casting. A flow-through substrate may be made, for example, by preparing a batch mixture, extruding the mixture through a die forming a honeycomb shape, drying, and optionally firing the support body.

In some exemplary embodiments, a flow-through substrate comprising activated carbon may be made by providing a batch composition comprising activated carbon particles and an organic or inorganic binder, shaping the batch composition, and optionally heat treating the flow-through substrate. In other exemplary embodiments, a flow-through substrate comprising activated carbon may be made by providing a batch composition comprising a carbon precursor, shaping the batch composition, optionally curing the composition, carbonizing the composition, and activating the carbonized composition.

Carbon precursors comprise synthetic carbon-containing polymeric material, organic resins, charcoal powder, coal tar pitch, petroleum pitch, wood flour, cellulose and derivatives thereof, natural organic materials such as wheat flour, wood flour, corn flour, nut-shell flour, starch, coke, coal, or mixtures or combinations of any two or more of these.

In some embodiments, the batch composition comprises an organic resin as a carbon precursor. Exemplary organic resins include thermosetting resins and thermoplastic resins (e.g., polyvinylidene chloride, polyvinyl chloride, polyvinyl alcohol, and the like). Synthetic polymeric material may be used, such as phenolic resins or a furfural alcohol based resin such as furan resins. Exemplary suitable phenolic resins are resole resins such as plyophen resins. An exemplary suitable furan liquid resin is Furcab-LP from QO Chemicals Inc., IN, U.S.A. An exemplary solid resin is solid phenolic resin or novolak.

The batch compositions may optionally also comprise inert inorganic fillers, (carbonizable or non-carbonizable) organic fillers, and/or binders. Inorganic fillers can include oxide glass; oxide ceramics; or other refractory materials. Exemplary inorganic fillers that can be used include oxygen-containing minerals or salts thereof, such as clays, zeolites, talc, etc., carbonates, such as calcium carbonate, alumninosilicates such as kaolin (an aluminosilicate clay), flyash (an aluminosilicate ash obtained after coal firing in power plants), silicates, e.g., wollastonite (calcium metasilicate), titanates, zirconates, zirconia, zirconia spinel, magnesium aluminum silicates, mullite, alumina, alumina trihydrate, boehmite, spinel, feldspar, attapulgites, and aluminosilicate fibers, cordierite powder, mullite, cordierite, silica, alumina, other oxide glass, other oxide ceramics, or other refractory material.

Additional fillers such as fugitive filler which may be burned off during carbonization to leave porosity behind or which may be leached out of the formed flow-through substrates to leave porosity behind, may be used. Examples of such fillers include polymeric beads, waxes, starch, natural or synthetic materials of various varieties known in the art.

Exemplary organic binders include cellulose compounds. Cellulose compounds include cellulose ethers, such as methylcellulose, ethylhydroxy ethylcellulose, hydroxybutylcellulose, hydroxybutyl methylcellulose, hydroxyethylcellulose, hydroxymethylcellulose, hydroxypropylcellulose, hydroxypropyl methylcellulose, hydroxyethyl methylcellulose, sodium carboxy methylcellulose, and mixtures thereof. An example methylcellulose binder is METHOCEL™ A, sold by the Dow Chemical Company. Example hydroxypropyl methylcellulose binders include METHOCEL™ E, F, J, K, also sold by the Dow Chemical Company. Binders in the METHOCEL™ 310 Series, also sold by the Dow Chemical Company, can also be used. METHOCEL™ A4M is an example binder for use with a RAM extruder. METHOCEL™ F240C is an example binder for use with a twin screw extruder.

The batch composition may also optionally comprise forming aids. Exemplary forming aids include soaps, fatty acids, such as oleic, linoleic acid, sodium stearate, etc., polyoxyethylene stearate, etc. and combinations thereof. Other additives that can be useful for improving the extrusion and curing characteristics of the batch are phosphoric acid and oil. Exemplary oils include petroleum oils with molecular weights from about 250 to 1000, containing paraffinic and/or aromatic and/or alicyclic compounds. Some useful oils are 3 in 1 oil from 3M Co., or 3 in 1 household oil from Reckitt and Coleman Inc., Wayne, N.J. Other useful oils can include synthetic oils based on poly (alpha olefins), esters, polyalkylene glycols, polybutenes, silicones, polyphenyl ether, CTFE oils, and other commercially available oils. Vegetable oils such as sunflower oil, sesame oil, peanut oil, soyabean oil etc. may also be useful.

After shaping a flow-through substrate from the batch composition, such as one comprising a curable organic resin, the flow-through substrate may optionally be cured under appropriate conditions. Curing can be performed, for example, in air at atmospheric pressures and typically by heating the composition at a temperature of from 70° C. to 200° C. for about 0.5 to about 5.0 hours. In some embodiments, the flow-through substrate is heated from a low temperature to a higher temperature in stages, for example, from 70° C., to 90° C., to 125° C., to 150° C., each temperature being held for a period of time. Additionally, curing may also be accomplished by adding a curing additive such as an acid additive at room temperature.

The cured flow-through substrate can then be subjected to a carbonization step. For instance, the cured flow-through substrate may be carbonized by subjecting the cured flow-through substrate to an elevated carbonizing temperature in an O₂-depleted atmosphere. The carbonization temperature can range from 600 to 1200° C., in some embodiments from 700 to 1000° C. The carbonizing atmosphere can be inert, comprising mainly a non reactive gas, such as N₂, Ne, Ar, mixtures thereof, and the like. At the carbonizing temperature in an O₂-depleted atmosphere, the organic substances contained in the cured flow-through substrate decompose to leave a carbonaceous residue.

The carbonized flow-through substrate may then be activated. The carbonized flow-through substrate may be activated, for example, in a gaseous atmosphere selected from CO₂, H₂O, a mixture of CO₂ and H₂O, a mixture of CO₂ and nitrogen, a mixture of H₂O and nitrogen, and a mixture of CO₂ and another inert gas, for example, at an elevated activating temperature in a CO₂ and/or H₂O-containing atmosphere. The atmosphere may be essentially pure CO₂ or H₂O (steam), a mixture of CO₂ and H₂O, or a combination of CO₂ and/or H₂O with an inert gas such as nitrogen and/or argon. Utilizing a combination of nitrogen and CO₂, for example, may result in cost savings. A CO₂ and nitrogen mixture may be used, for example, with CO₂ content as low as 2% or more. Typically a mixture of CO₂ and nitrogen with a CO₂ content of 5-50% may be used to reduce process costs. The activating temperature can range from 600° C. to 1000° C., in certain embodiments from 600° C. to 900° C. During this step, part of the carbonaceous structure of the carbonized flow-through substrate is mildly oxidized:

CO₂(g)+C(s)→2CO(g),

H₂O(g)+C(s)→H₂(g)+CO(g),

resulting in the etching of the structure of the carbonaceous flow-through substrate and formation of an activated carbon matrix that can define a plurality of pores on a nanoscale and microscale. The activating conditions (time, temperature, and atmosphere) can be adjusted to produce the final product with the desired specific area.

In some embodiments, the activated carbon surface is present as a layer on a flow-through substrate. For example, the flow-through substrate is coated with a layer that comprises activated carbon. The term “layer” as used herein means that activated carbon is disposed on an exposed surface of the flow-through substrate. The layer may coat all or a portion of the surface of the flow-through substrate, and may impregnate the flow-through substrate to some extent, for example in embodiments that comprise a flow-through substrate with a porous surface. For instance, the layer may coat the inner pore and/or channel surfaces of a flow-through substrate and/or other outer surfaces of the flow-through substrate. In some embodiments, the activated carbon is in the form of an uninterrupted and continuous layer over all or a portion of the surface of the flow-through substrate. In other embodiments, the layer of activated carbon includes cracks, pinholes, or other discontinuities. The layer may further comprise other suitable materials in addition to the activated carbon.

Embodiments disclosed herein include a method comprising treating a flow-through substrate comprising an activated carbon surface wherein the treating comprises contacting an acid or oxidizing agent to the activated carbon surface and contacting a hydrophobic compound to the activated carbon surface. Contacting an acid or oxidizing agent to the activated carbon surface acts to introduce acidic functional groups to the activated carbon surface thereby reducing and/or inhibiting adsorption of acid gases by the activated carbon surface. Contacting the acid or oxidizing agent to the activated carbon surface may occur via dip coating, spray drying or vacuum coating. As examples, the acid or oxidizing agent can be applied by dipping the activated carbon surface in a solution comprising the acid or oxidizing agent, spraying a solution comprising the acid or oxidizing agent on the activated carbon surface or utilizing a vacuum to “draw” the solution comprising the acid or oxidizing agent into and through an activated carbon substrate. As an alternative, the acid or oxidizing agent may be contacted with the activated carbon surface in a gas phase.

A suitable solvent is selected to prepare the solution comprising an acid or oxidizing agent. For example, water may be used as a solvent to prepare the solution comprising an acid or oxidizing agent. Other suitable solvents include organic solvents, such as ethanol, ethyl acetate, or isopropanol.

As an example, in some embodiments using an acid to treat the activated carbon surface of a honeycomb shaped flow-through substrate, the activated carbon honeycomb is soaked in an aqueous solution of the acid at room temperature or higher for about 5 minutes to about 60 minutes. The activated carbon honeycomb is then removed and washed with distilled water until substantially free of ions from the acid. The activated carbon honeycomb is then dried at a temperature of about 90° C. to about 120° C., for about 30 minutes to about 24 hours. In some embodiments, the acid is selected from hydrochloric acid, phosphoric acid, sulfuric acid, benzoic acid, and combinations thereof. An appropriate concentration of the acid is selected to prevent degradation of the activated carbon surface. For example, if the acid concentration is too high, the activated carbon surface may be degraded during contact with the acid.

As an example, in some embodiments using an oxidizing agent to treat the activated carbon surface of a honeycomb shaped flow-through substrate, the activated carbon honeycomb is soaked in an aqueous solution of the oxidizing agent at room temperature or higher for about 30 minutes. The activated carbon honeycomb is then removed and dried for about 30 minutes or longer at a temperature of about 90° C. to about 120° C. In embodiments, the oxidizing agent is selected from phenolic hydroxyl, quinine, carboxylic acid, oxyacids, peroxides, persulfates, and combinations thereof. It is generally advantageous during contact between the oxidizing agent and activated carbon surface to maintain the oxidizing agent at a concentration and time sufficient to incorporate oxygen onto the activated carbon pore surface in the form of oxygen functional groups such as phenolic hydroxyl, quinone, and carboxylic acid groups.

Contacting a hydrophobic compound to the activated carbon surface acts to render the pore surfaces of the activated carbon surface repellant to water, thereby reducing and/or inhibiting adsorption of water by the activated carbon surface. Contacting the hydrophobic compound to the activated carbon surface may occur via dip coating or spray drying. As examples, the hydrophobic compound can be applied by dipping the activated carbon surface in a solution comprising the hydrophobic compound, or spraying a solution comprising the hydrophobic compound on the activated carbon surface.

As an example, in embodiments using a hydrophobic compound to treat the activated carbon surface of a honeycomb shaped flow-through substrate, the activated carbon honeycomb is soaked in a solution comprising a hydrophobic compound at room temperature or higher for about 5 minutes to about 60 minutes. The activated carbon honeycomb is then dried at a temperature of about 50° C. to about 120° C., for about 30 minutes or longer. In embodiments, the hydrophobic compound is selected from perfluorinated alcohol, methylated medium chain alkyl silanes, and linear or branched hydrocarbons of the general formula CₙH₂ₙ₊₂, wherein n equals 9 to 12. In one embodiment, the hydrophobic compound is nonane. An appropriate hydrophobic compound does not interfere with or inhibit the capabilities of the activated carbon to sorb a toxic metal.

In some embodiments, the oxidizing agent is ammonium persulfate and the hydrophobic compound is nonane. In some embodiments, the acid or oxidizing agent and hydrophobic compound may be combined and contacted with the activated carbon surface at the same time.

The acid or oxidizing agent and hydrophobic compound may be referred to collectively as surface modifying agents. In some embodiments, the method of contacting a surface modifying agent to an activated carbon surface is selected such that the pore structure of the activated carbon surface is not substantially changed by the surface modifying agent. Generally, it is advantageous to achieve a maximum amount of acidic functional groups and hydrophobic compound on the treated activated carbon surface without reducing the ability of the flow-through substrate to capture a toxic metal.

In some embodiments, the flow-through substrate comprises at least 3 wt % to 20 wt % of surface modifying agents. For example, 5 wt %, 10 wt %, or 15 wt % of surface modifying agent is present in or on the flow-through substrate.

Embodiments disclosed herein include a method of treating a fluid stream comprising a toxic metal, the method comprising contacting a fluid stream comprising a toxic metal with a flow-through substrate as described above and removing at least a portion of the toxic metal from the fluid stream. Embodiments of flow-through substrates, such as a honeycomb shaped flow-through substrate, may be used, for example, for the sorption of a toxic metal from a fluid through contact with the fluid. For example, a fluid stream may be passed through inner passageways of a flow-through substrate from the inlet end to the outlet end. The fluid stream may be in the form of a gas or a liquid. The gas or liquid may also contain another phase, such as a solid particulate in either a gas or liquid stream, or droplets of liquid in a gas stream. Example gas streams include coal combustion flue gases (such as from bituminous and sub-bituminous coal types or lignite coal) and syngas streams produced in a coal gasification process.

In some embodiments, the contacting of the fluid stream with the flow-through substrate occurs at a temperature in the range of from 100° C. to 300° C.

The terms “remove,” “removal,” and “removing” used to describe the removal of a toxic metal from the fluid stream refer to reducing the content of the toxic metal in the fluid stream to any extent. Thus, removal of a toxic metal from a fluid stream includes removing, for example, at least 50%, at least 60%, at least 70%, at least 80%, at least 90%, or at least 95% of the toxic metal from the fluid stream, or removing 100% of the toxic metal from the fluid stream.

In embodiments disclosed herein the at least a portion of the toxic metal is removed from the fluid stream via sorption. The term “at least a portion” in this and other contexts refers to some or all of the material being described. Thus in these embodiments, some or all of the toxic metal may be removed from the fluid stream. The terms “sorb,” “sorption,” and “sorbed,” refer to the adsorption, sorption, or other entrapment of the toxic metal on the flow-through substrate, either physically, chemically, or both physically and chemically.

Toxic metals to be removed include, for instance, toxic metals at 3 wt % or less within the fluid stream, for example at 2 wt % or less, or 1 wt % or less. Toxic metals may also include, for instance, toxic metals at 10,000 μg/m³ or less within the fluid stream. The term “toxic metal” and any reference to a particular metal by name herein includes the elemental forms as well as oxidation states of the metal. Removal of a toxic metal thus includes removal of the elemental form of the metal as well as removal of any organic or inorganic compound or composition comprising the metal.

Example “toxic metals” that can be sorbed include cadmium, mercury, chromium, lead, barium, beryllium, arsenic, selenium, and chemical compounds or compositions comprising those elements. For example, the metal mercury may be in an elemental (Hg°) or oxidized state (Hg⁺ or Hg²⁺). Example forms of oxidized mercury include HgO and halogenated mercury, for example Hg₂Cl₂ and HgCl₂.

In various embodiments of the present disclosure, the flow-through substrates disclosed herein are capable of removing at least one toxic metal from a fluid stream. In some embodiments, the toxic metal is mercury.

The toxic metal may be in any phase that can be sorbed on the flow-through substrate. Thus, the toxic metal may be present, for example, as a liquid in a gas fluid steam, or as a liquid in a liquid fluid stream. The toxic metal could alternatively be present as a gas phase contaminant in a gas or liquid fluid stream.

The articles and methods disclosed herein work to increase the effectiveness and life of the flow-through substrate for adsorption of a toxic metal by reducing the adsorption of acid gases, for example SO₂, and moisture. Sulfur compounds in the flue gas react with water which is adsorbed on the surface of the carbon to form sulfuric acid that penetrates the pores and affects the adsorption capacity of the flow-through substrate. The formation of sulfuric acid on carbon surface can be represented by the following reaction steps:

SO_{2,gas} [symbol] SO_{2,adsorbed}

SO_{2,adsorbed}+½O_{2,adsorbed} [symbol] SO_{3,adsorbed}

SO_{3,adsorbed}+H₂O [symbol] H₂SO₄

The presence of sulfuric acid may reduce to some degree, or entirely prevent, the sorption of a toxic metal on a flow-through substrate compared to the absence of the sulfuric acid in the gas stream. For example, the sulfuric acid may reduce sorption of the toxic metal by reducing the capacity of the sorbent material, by reducing the capture efficiency of the flow-through substrate, by reducing the rate of toxic metal capture by the flow-through substrate, or by a combination of these effects. The sulfuric acid may reduce the sorption of a toxic metal on the flow-through substrate through physical and/or chemical mechanisms. For example, the sulfuric acid may physically occupy or otherwise block access to pore sites on the flow-through substrate. Alternatively, or in addition, the sulfuric acid may detrimentally chemically react with the flow-through substrate.

Without being bound by theory, it is believed that the hydrophobic treatment will rendering the activated carbon surface repellant to water, thus reducing the accumulation of moisture in the pores. It is also believed that the oxidizing agent introduces oxygen functional groups to the activated carbon surface or directly occupies the basic sites of the activated carbon surface, which in either case reduces the basic sites for adsorption of acid gases particularly SO₂.

Various embodiments will be further clarified by the following examples.

### Example 1

An untreated activated carbon honeycomb (ACH) and an ACH treated with trimethylchlorosilane (TMSCL), a hydrophobic compound, according to the methods described above were exposed to mercury-free simulated flue gas for 18 hours. The test was done at 150 C. The flue gas contained N₂, CO₂, 5% O₂, 900 ppm SO₂ and 6% moisture. The untreated sample showed a 3.9% weight gain, while the hydrophobic compound treated sample showed zero weight gain after exposure to simulated flue gas for 18 hours.

### Example 2

An untreated ACH and ACH pretreated with benzoic acid (BZA) and Bis[3-(triethoxysilyl)propyl]tetrasulfide (TS4) according to the methods described above, were exposed to standard mercury-laden Powder River Basin (PRB) simulated flue gas at 150° C. for 6 days each. The pH of the untreated ACH changed from 9.8 before to 2.5 after flue gas exposure. The pH of the treated ACH changed from 8.8 before to 7.9 after flue gas exposure.

### Example 3

An untreated ACH and an ACH pretreated with benzoic acid (BZA) and nonane, carbon 9 (NON) according to the methods described above, were exposed to standard PRB simulated flue gas at 150° C. The untreated ACH showed a 12.5% weight gain in sulfate levels, while the treated ACH showed a 0.83% weight gain in sulfate levels after exposure to the flue gas.

The disclosed examples demonstrate that treatment of an ACH with an acid or oxidizing agent and a hydrophobic compound, before being exposed to simulated flue gas, can substantially reduce the adsorption affinities of the activated carbon surface for acid gases in the gas stream.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A flow-through substrate comprising a treated activated carbon surface;
wherein the treated activated carbon surface comprises acidic functional groups; and
wherein the treated activated carbon surface comprises a hydrophobic compound.

2. A flow-through substrate of claim 1, wherein the treated activated carbon surface has a surface area greater than 400 m²/g.

3. A flow-through substrate of claim 1, wherein the flow-through substrate is honeycomb shaped.

4. A flow-through substrate of claim 1, wherein the treated activated carbon surface is a layer on a flow-through substrate.

5. A flow-through substrate of claim 1, wherein the treated activated carbon surface has a pH of from 2 to 7.

6. A flow-through substrate of claim 1, wherein the treated activated carbon surface comprises at least 3 weight percent to 20 weight percent of acidic functional groups and hydrophobic compound combined.

7. A method comprising:
treating a flow-through substrate comprising an activated carbon surface to form a treated activated carbon surface;
wherein the treating comprises:
contacting an acid or oxidizing agent to the activated carbon surface; and
contacting a hydrophobic compound to the activated carbon surface.

8. A method of claim 7, wherein the acid or oxidizing agent is selected from hydrochloric acid, phosphoric acid, sulfuric acid, benzoic acid, phenolic hydroxyl, quinine, carboxylic acid, oxyacids, peroxides, persulfates, and combinations thereof.

9. A method of claim 7, wherein the acid is selected from hydrochloric acid, phosphoric acid, sulfuric acid, benzoic acid, and combinations thereof.

10. A method of claim 7, wherein the oxidizing agent is selected from phenolic hydroxyl, quinine, carboxylic acid, oxyacids, peroxides, persulfates, and combinations thereof.

11. A method of claim 7, wherein the oxidizing agent is ammonium persulfate.

12. A method of claim 7, wherein the hydrophobic compound is selected from perfluorinated alcohol, methylated medium chain alkyl silanes, and linear or branched hydrocarbons of the general formula CₙH₂ₙ₊₂, wherein n equals 9 to 12.

13. A method of claim 7, wherein the hydrophobic compound is nonane.

14. A method of claim 7, wherein the treated activated carbon surface has a surface area greater than 400 m²/g.

15. A method of claim 7, wherein the flow-through substrate is honeycomb shaped.

16. A method of claim 7, wherein the activated carbon surface is a layer on a flow-through substrate.

17. A method of claim 7, wherein the contacting an acid or oxidizing agent to the activated carbon surface occurs prior to the contacting the hydrophobic compound to the activated carbon surface.

18. A method comprising:
contacting a fluid stream comprising a toxic metal with the flow-through substrate of claim 1; and
removing at least a portion of the toxic metal from the fluid stream.

19. A method of claim 18, wherein the fluid stream is a liquid or a gas.

20. A method of claim 18, wherein the toxic metal is mercury.
